(19) United States
(12) Patent Application Publication
(10) Pub. No.: US 2003/0210794 A1
(43) Pub. Date: Nov. 13, 2003

(54) Matrix surround decoding system

(75) Inventors: Koichi Sato, Yamagata-ken (JP); Takashi Kaneko, Yamagata-ken (JP)

Correspondence Address: ARENT FOX KINTNER PLOTKIN & KAHN, PLLC, 1050 Connecticut Avenue, N.W., Suite 600, Washington, DC, 20036-5339, US

(73) Assignees: Pioneer Corporation; Tohoku Pioneer Corporation

(21) Appl. No.: 10/408,099

(22) Filed: Apr. 8, 2003

(30) Foreign Application Priority Data
May 10, 2002 (JP) 2002-135861

(51) Int. Cl. H04R 5/00

(52) U.S. Cl. 381/22; 381/17; 381/18; 381/19

(57) ABSTRACT

A matrix surround decoding system comprises a DIR 10 detecting a sampling frequency FS included in a stereophonic source, and a microcomputer 12 determining the type of stereo source on the basis of the sampling frequency detected by the DIR 10, and outputting to a matrix surround decoder 11 a mode switching signal CL for switching the output mode of the matrix surround decoder 11 to a mode corresponding to the determined type of stereophonic source.

### BACKGROUND OF THE INVENTION

1. Field of the Invention

This invention relates to a matrix surround decoding system for expanding a two-channel stereophonic source to a multichannel source for reproduction.

The present application claims priority from Japanese Application No. 2002-135861, the disclosure of which is incorporated herein by reference.

2. Description of the Related Art

In recent years, the development of matrix surround decoding techniques for expanding a two-channel stereophonic source to a multichannel (e.g. 5.1 channel) source for audio reproduction has provided a way to create a three-dimensional sound effect for a two-channel source, such as a CD conventionally recorded in stereo, by means of multichannel surround reproduction.

FIG. 4 is a block diagram illustrating the configuration of a matrix surround decoding system in the prior art.

In FIG. 4, a digital-audio interface receiver (hereinafter referred to as “DIR”) 1 receives input of two-channel digital audio data from audio equipment of various types.

As used herein, the two-channel digital audio data refers to a surround-encoded stereo signal or a general unencoded stereo signal.

The DIR 1 carries out demodulation to extract a clock and data from the digital audio data, and then outputs the resulting clock (CK) and data (DATA) to a matrix surround decoder 2.

Then, by use of thematrix surround decoding techniques, the matrix surround decoder 2 produces 5.1-channel signals, consisting of a left front signal L, a right front signal R, a center signal C, a left surround signal LS, a right surround signal RS and a sub-woofer signal LFE, from the two-channel data (DATA) supplied from the DIR 1 in accordance with the associated clock (CK), and then outputs the resulting signals.

FIG. 4 also illustrates a stereo-downmixing processor 3. Before the stereo-downmixing processor 3 outputs, to headphones, the audio signals for the respective channels resulting from the expansion to a 5.1 channel in the matrix surround decoder 2, the processor 3 combines (i.e. performs the stereo-downmixing) the left front signal L, the right front signal R, the center signal C, the left surround signal LS, the right surround signal RS and the sub-woofer signal LFE, which are supplied from the matrix surround decoder 2, on the basis of preset downmixing coefficients, to produce two-channel surround headphone output signals Lo and Ro for outputting to the headphones.

The matrix surround decoder 2, if it is e.g. a Dolby Pro Logic II decoder (“Dolby” and “Pro Logic” are trademarks of Dolby Laboratories Inc), is capable of switching the output mode into at least two mode, a movie mode and a music mode, when expanding the two-channel data (DATA) to the 5.1 channel by use of the matrix surround decoding techniques.

The movie mode has parameters optimized for the reproduction of movies, and is designed to provide Haas (or Precedence) effect to make crosstalk of dialog to the surround channel less perceptible to the ear.

The music mode has parameters optimized for reproduction of music, and is designed to tune the surround channel so as to create a sense of more spaciousness of sound and more realistic ambience than those created when an acoustic image is normally positioned.

Conventionally, the user manually switches between the movie mode and the music mode in the matrix surround decoding system, as described above, depending upon the type of input source. The user operates the switch, whereupon a mode switch signal is inputted to the matrix surround decoder 2 to select the parameter required for the matrix surround decoding in the matrix surround decoder 2.

However, such prior-art matrix surround decoding systems have the considerable inconvenience of switching the output mode in correspondence with the type of source to be reproduced on an as-needed basis, and further the problem of the impossibility of the most suitable surround reproduction when the switched output mode mismatches the input source to be reproduced.

### SUMMARY OF THE INVENTION

The present invention has been made to solve the problems associated with the prior-art matrix surround decoding systems as described above.

It is therefore an object of the present invention to provide a matrix surround decoding system capable of automatically selecting the most suitable output mode in response to the type of a two-channel input source when the input source undergoes matrix surround decoding.

To attain the above object, a matrix surround decoding system in a first feature according to the present invention includes a matrix surround decoder to expand a two-channel stereophonic source to a multichannel source for reproduction; a sampling frequency detecting member detecting a sampling frequency included in the stereophonic source; and an output mode switching member determining a type of the stereophonic source on the basis of the sampling frequency detected by the sampling frequency detecting member, and outputting to the matrix surround decoder a mode switching signal for switching an output mode of the matrix surround decoder to a mode corresponding to the determined type of the stereophonic source.

The sampling frequency detecting member of the matrix surround decoding system in the first feature detects a sampling frequency included in a signal of an incoming two-channel stereophonic source, and supply information about the detected sampling frequency to the output mode switching member.

Upon reception of the information about the sampling frequency supplied from the sampling frequency detecting member, the output mode switching member determines the type of stereophonic source including the sampling frequency concerned, on the basis of the supplied information about the sampling frequency.

Then the output mode switching member outputs a mode switching signal, for switching the matrix surround decoder to an output mode corresponding to the determined type of stereophonic source, to the matrix surround decoder expanding the two-channel stereophonic source to a multichannel source, so that the matrix surround decoder is switched to the output mode corresponding to the type of stereophonic source which is to be expanded to a multichannel source for reproduction.

According to the first feature as described above, the output mode of the matrix surround decoder expanding the two-channel stereophonic source to the multichannel source for reproduction is automatically switched to a mode corresponding to the type of stereophonic source, in accordance with each type of stereophonic source to be expanded to a multichannel source. Hence, the user is relieved of the inconvenience of manually switching the output mode of the matrix surround decoder every time. In addition, this design guards against the possibility of optimum surround reproduction becoming unachievable because of a mismatch of the input source and the output mode of the matrix surround decoder.

To attain the aforementioned object, in the matrix surround decoding system in a second feature according to the present invention, in addition to the configuration of the first feature, the output mode switching member determines whether the stereophonic source is an image source or a music source on the basis of the sampling frequency detected by the sampling frequency detecting member, and outputs to the matrix surround decoder the mode switching signal for switching the output mode of the matrix surround decoder to an image mode when it is determined that the stereophonic source is the image source, and outputs to the matrix surround decoder the mode switching signal for switching the output mode of the matrix surround decoder to a music mode when it is determined that the stereophonic source is the music source.

According to the second feature, a determination is made by the output mode switching member as to whether the type of stereophonic source is an image source or a music source. If the output mode switching member determines that the type of stereophonic source is an image source, in order to switch the matrix surround decoder to the image mode, the output mode switching member sends to the matrix surround decoder a mode switching signal for switching the output mode of the matrix surround decoder to the image mode. If the output mode switching member determines that it is a music source, in order to switch the matrix surround decoder to the music mode, the output mode switching member sends to the matrix surround decoder a mode switching signal for switching the output mode of the matrix surround decoder to the music mode.

This design allows the automatic switching between the image mode and the music mode of the output mode of the matrix surround decoder.

To attain the aforementioned object, in the matrix surround decoding system in a third feature according to the present invention, in addition to the configuration of the first feature, the output mode switching member determines that the stereophonic source is an image source when the sampling frequency detected by the sampling frequency detecting member is 48 kHz, and outputs to the matrix surround decoder the mode switching signal for switching to an image mode, and similarly determines that the stereophonic source is a music source when the sampling frequency detected by the sampling frequency detecting member is 44.1 kHz, and outputs to the matrix surround decoder the mode switching signal for switching to a music mode.

According to the third feature, when the sampling frequency detected by the sampling frequency detecting member is 48 kHz, the output mode switching member determines that the type of stereophonic source is an image source, and sends to the matrix surround decoder a mode switching signal for switching the output mode of the matrix surround decoder to the image mode. When the sampling frequency detected by the sampling frequency detecting member is 44.1 kHz, the output mode switching member determines that the type of stereophonic source is a music source, and sends to the matrix surround decoder a mode switching signal for switching the output mode of the matrix surround decoder to the music mode.

To attain the aforementioned object, in the matrix surround decoding system according to a fourth feature, in addition to the configuration of the first feature, the sampling frequency detecting member is a digital audio interface receiver performing demodulation to extract a clock and data from a signal of the stereophonic source.

According to the fourth feature, when the digital audio interface receiver serving as the sampling frequency detecting member performs demodulation to extract a clock and data from a signal of the incoming stereophonic source, the digital audio interface receiver detects information about the sampling frequency included in the digital audio data of the stereophonic source, and sends the detected information about the sampling frequency to the output mode switching member.

These and other objects and features of the present invention will become more apparent from the following detailed description with reference to the accompanying drawings.

### BRIEF DESCRIPTION OF THE DRAWINGS

FIG. 1 is a block diagram illustrating an embodiment according to the present invention.

FIG. 2 is a block diagram illustrating a circuit configuration of a matrix surround decoder in the embodiment.

FIG. 3 is a table showing the characteristics of the functions of output mode of the matrix surround decoder.

FIG. 4 is a block diagram illustrating an example of the prior art.

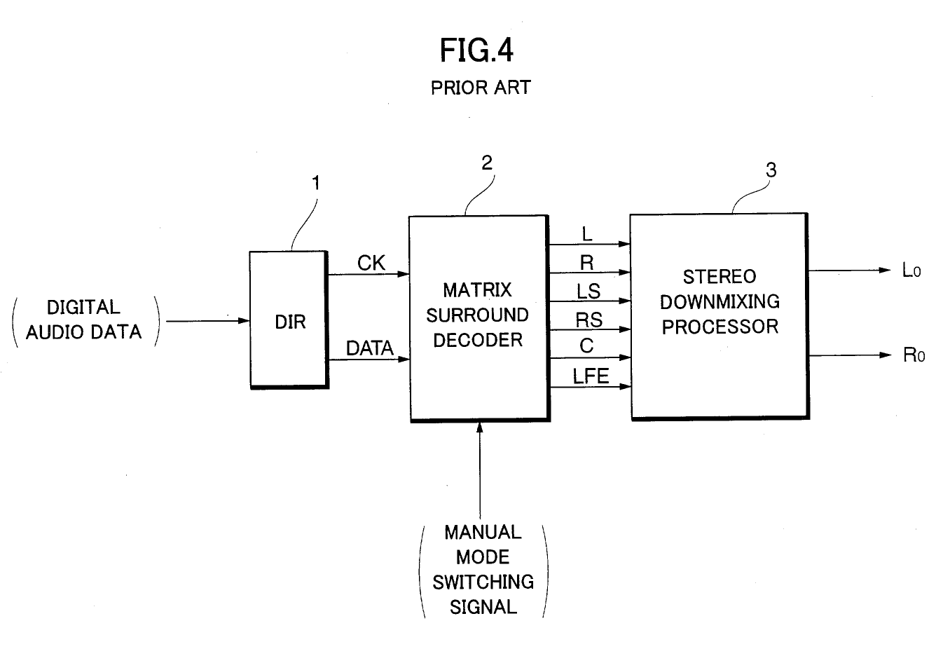

### DETAILED DESCRIPTION OF THE PREFERRED EMBODIMENT

A preferred embodiment according to the present invention will be described hereinafter in detail with reference to the accompanying drawings.

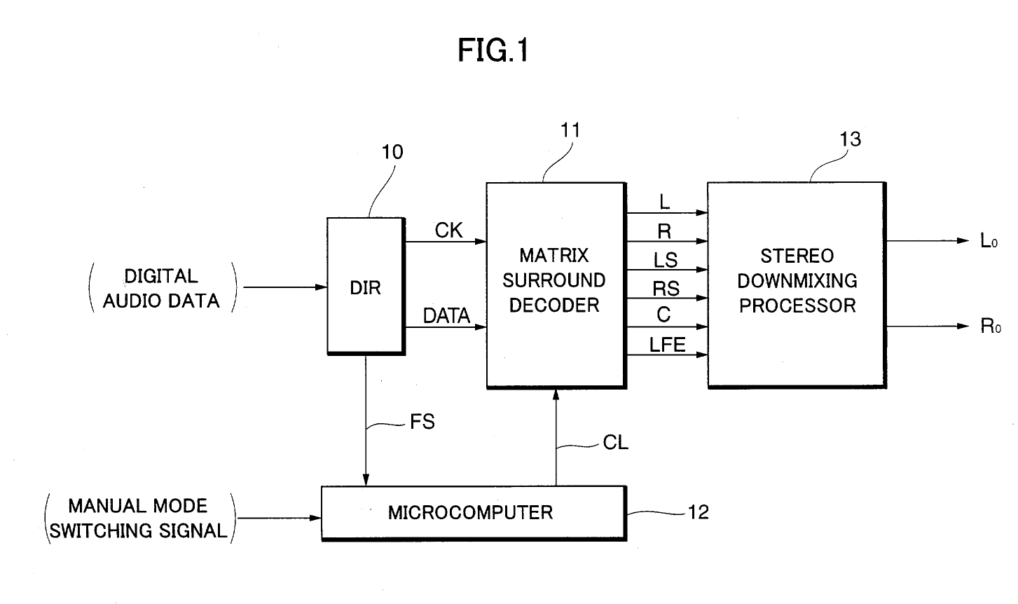

FIG. 1 is a block diagram illustrating the configuration of a matrix surround decoding system in an embodiment according to the present invention.

In FIG. 1, the matrix surround decoding system includes a DIR (digital-audio interface receiver) 10, a matrix surround decoder 11, and also a microcomputer 12 connected to the DIR 10 and the matrix surround decoder 11.

FIG. 1 also illustrates a stereo-downmixing processor 13. Before 5.1-channel source signals resulting from expansion in the matrix surround decoder 11 are outputted to headphones, the stereo-downmixing processor 13 mixes down the 5.1-channel source signals to produce two-channel surround headphone output signals Lo and Ro.

As described later, the microcomputer 12 acquires information about the sampling frequency (FS), included in digital audio data, from the DIR 10, and determines the type of input source on the basis of the acquired information about the sampling frequency. Then, the microcomputer 12 switches the output mode of the matrix surround decoder 11 on the basis of the determination.

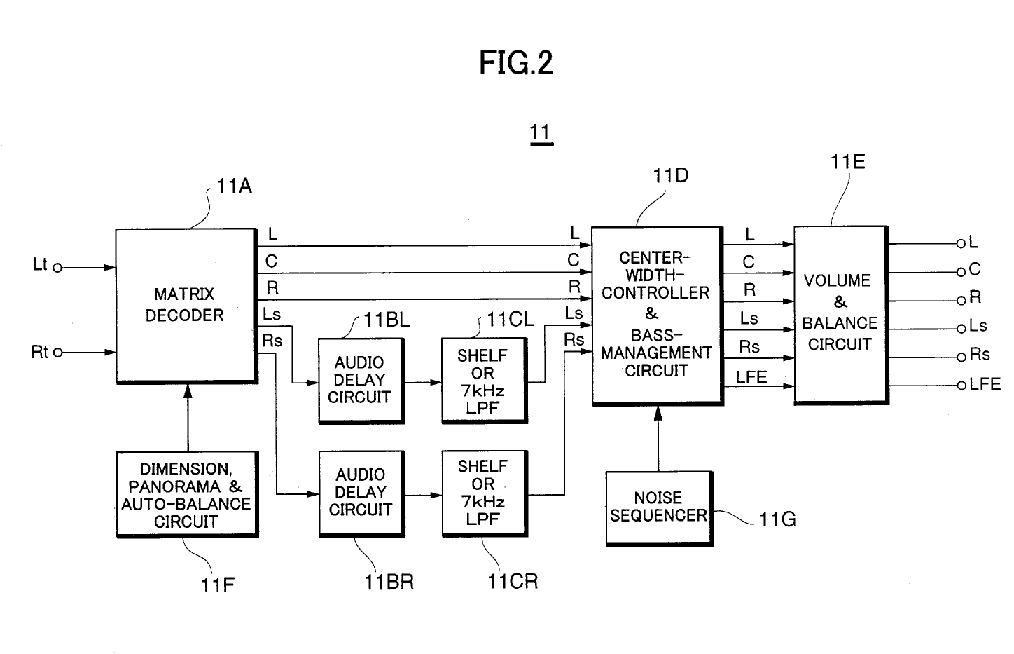

FIG. 2 is a block diagram illustrating the configuration of a Dolby Pro Logic II decoder serving as the matrix surround decoder 11.

In FIG. 2, the matrix surround decoder 11 includes: a matrix decoder 11A extracting front channel signals (L, R), a center channel signal (C), surround channel signals (LS, RS) from the two-channel data (Lt, Rt) supplied from the DIR 10 (see FIG. 1), and outputting the resulting signals; audio delay circuits 11BL and 11BR respectively connected to an output terminal for the left surround signal (LS) and an output terminal for the right surround signal (RS) of the matrix decoder 11A; associated shelf or 7-kHz low-pass filters 11CL and 11CR; a center-width-controller and bass-management circuit 11D; and a volume and balance circuit 11E.

The matrix surround decoder 11 further includes a dimension, panorama and auto-balance circuit 11F connected to the matrix decoder 11A, and carrying out a dimension control, a panorama control, and the switching to an auto-balance mode in the matrix decoder 11A; and a noise sequencer 11G connected to the center-width-controller and bass-management circuit 11D.

Next, a description will be below given of the operation in switching the output mode of the matrix surround decoder 11 in the matrix surround decoding system.

When the DIR 10 performs demodulation to extract a clock (CK) and data (DATA) from incoming digital audio data, the DIR 10 detects information about the a sampling frequency (FS) included in the digital audio data, and then outputs a detection signal FS representative of the detected sampling frequency to the microcomputer 12.

When the detection signal FS supplied from the DIR 10 to the microcomputer 12 represents the sampling frequency of the incoming digital audio data as FS=48 kHz, indicating that the source of the digital audio data is a movie source such as a DVD, a video tape (analog input) or the like, the microcomputer 12 outputs a mode switching signal CL to the matrix surround decoder 11 for switching the output mode of the decoder 11 to a movie mode.

Based on the detection signal FS supplied from the DIR 10, the microcomputer 12 outputs a mode switching signal CL to the matrix surround decoder 11 for switching the output mode of the decoder 11 to a movie mode when the sampling frequency of the incoming digital audio data is FS=48 kHz, indicating that the source of the digital audio data is a movie source such as a DVD, a video tape (analog input) or the like.

Alternatively based on the detection signal FS supplied from the DIR 10, the microcomputer 12 outputs a mode switching signal CL to the matrix surround decoder 11 for switching the output mode to a music mode when the sampling frequency of the incoming digital audio data is FS=44.1 kHz, indicating that a source of the digital audio data is a music source such as a CD or the like.

When the user manually inputs a switching signal for switching to the movie mode or the music mode, or alternatively to another mode such as a virtual mode, a matrix mode, a Pro Logic emulation mode or the like which are preset in the matrix decoder 11, the microcomputer 12 outputs the switching signal to the matrix surround decoder 11 for switching to the corresponding output mode.

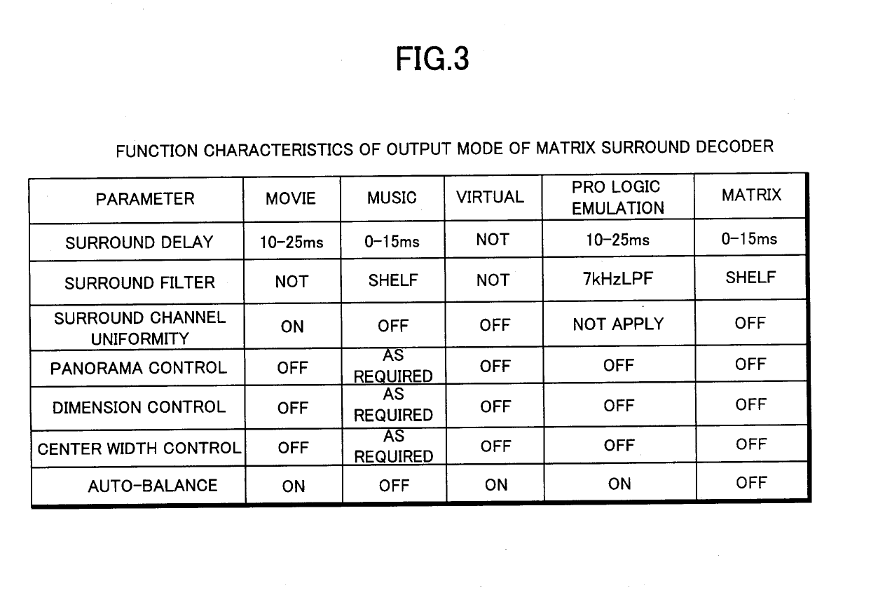

FIG. 3 shows characteristics of the functions of each output mode in the matrix surround decoder 11.

As shown in FIG. 3, the matrix surround decoder 11 is switched to the movie mode by the mode switching signal CL sent from the microcomputer 12, whereupon the audio delay circuits 11BL and 11BR are switched to cause a delay ranging from 10 ms to 25 ms in the surround signals (LS, RS), outputted from the respective output terminals of the matrix decoder 11A, in relation to the front signals (L, R) and the center signal (C), and the shelf or 7-kHz low-pass filters 11CL and 11CR are turned off so as not to filter the signal passing therethrough.

A surround channel uniformity function for setting the surround speakers in phase is turned on. Both the panorama control and the dimension control actuated by the dimension, panorama and auto-balance circuit 11F are turned off, but the auto-balance mode is turned on. The center width control actuated by the center-width-controller and bass-management circuit 11D is turned off.

When the matrix surround decoder 11 is switched to the music mode by the mode switching signal CL sent from the microcomputer 12, the audio delay circuits 11BL and 11BR are switched to produce a delay ranging from zero to 15 ms in the surround signals (LS, RS) outputted from the respective output terminals of the matrix decoder 11A in relation to the front signals (L, R) and the center signal (C), and the shelf or 7-kHz low-pass filters 11CL and 11CR serves as the shelf filters for the resulting signals.

The surround channel uniformity function for setting the surround speakers in phase is turned off. The auto-balance mode actuated by the dimension, panorama and auto-balance circuit 11F is turned off. The panorama control and the dimension control actuated by the dimension, panorama and auto-balance circuit 11F, and the center width control actuated by the center-width-controller and bass-management circuit 11D are available singly or in combination as required.

FIG. 3 shows, in addition to the movie mode and the music mode, the characteristics of the functions of the Pro Logic emulation mode for offering the original surround process to the user when the source contents are of a low sound quality or when the listener desires to listen to the program with the sound quality to which he/she is accustomed, and also the characteristics of the functions of the virtual mode and the matrix mode.

As described above, with the matrix surround decoding system, the information about the sampling frequency is detected from the incoming digital audio data in which it is included. Based on the detected sampling frequency, the output mode in the matrix surround decoder is automatically switched to the movie mode or the music mode in accordance with the input source of the digital audio data. This design eliminates the inconvenience of the user having to switch modes manually every time, and also prevents the possibility of optimized surround reproduction becoming unachievable because of a mismatch of the input source and the output mode in the matrix surround decoder.

The foregoing has given the switching between the two modes, the movie mode and the music mode, by way of example. If sampling frequencies of three or more types of input sources are standardized, the mode switching may be performed among three or more modes corresponding to the respective sampling frequencies.

The terms and description used herein are set forth by way of illustration only and are not meant as limitations. Those skilled in the art will recognize that numerous variations are possible within the spirit and scope of the invention as defined in the following claims.

What is claimed is:

1. A matrix surround decoding system including a matrix surround decoder to expand a two-channel stereophonic source to a multichannel source for reproduction, comprising:
a sampling frequency detecting member detecting a sampling frequency included the stereophonic source; and
an output mode switching member determining a type of the stereophonic source on the basis of the sampling frequency detected by the sampling frequency detecting member, and outputting to the matrix surround decoder a mode switching signal for switching an output mode of said matrix surround decoder to a mode corresponding to the determined type of the stereophonic source.

2. A matrix surround decoding system according to claim 1, wherein said output mode switching member determines whether the stereophonic source is an image source or a music source on the basis of the sampling frequency detected by said sampling frequency detecting member, and outputs to said matrix surround decoder the mode switching signal for switching the output mode of said matrix surround decoder to an image mode when it is determined that the stereophonic source is the image source, and outputs to said matrix surround decoder the mode switching signal for switching the output mode of said matrix surround decoder to a music mode when it is determined that the stereophonic source is the music source.

3. A matrix surround decoding system according to claim 1, wherein said output mode switching member determines that the stereophonic source is an image source when the sampling frequency detected by said sampling frequency detecting member is 48 kHz, and outputs to the matrix surround decoder the mode switching signal for switching to an image mode, and similarly determines that the stereophonic source is a music source when the sampling frequency detected by said sampling frequency detecting member is 44.1 kHz, and outputs to the matrix surround decoder the mode switching signal for switching to a music mode.

4. A matrix surround decoding system according to claim 1, wherein said sampling frequency detecting member is a digital audio interface receiver performing demodulation to extract a clock and data from a signal of the stereophonic source.
